(19) United States
(12) Patent Application Publication
(10) Pub. No.: US 2009/0198549 A1
(43) Pub. Date: Aug. 6, 2009

(54) Automated Repair System and Method for Network-Addressable Components

(76) Inventors: James A. Kearns, Cypress, TX (US); Bruce M. Wrobel, Cypress, TX (US); Lynn Richardson, Kirkland, WA (US); Benjamin F. Clardy, Spring, TX (US); Geoffery A. Schunicht, Spring, TX (US); Stephen Marzulla, Colorado Springs, CO (US); Randolph J. Wolf, Monument, CO (US); Steven W. Hoffmann, Sterling, MA (US); Russ B. Bracewell, Colorado Springs, CO (US); Chad A. Masters, Colorado Springs, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/237,120

(22) Filed: Sep. 24, 2008

Related U.S. Application Data
(60) Provisional application No. 61/006,793, filed on Jan. 31, 2008.

(51) Int. Cl. G06Q 10/00

(52) U.S. Cl. 705/8

(57) ABSTRACT

A system, and a corresponding method provide for automated repair of network-addressable components belonging to an enterprise. The system includes a service event filter that receives information related to the operation of the component and in real time determines if the received information indicates a serviceable event; and a service event analyzer coupled to the service event filter. The service event analyzer determines in real time an applicable procedure for repair or replacement of the component, and formats in real time the information related to the operation of the component and the applicable procedure into a machine-readable message. Finally, the system includes a serviceable event interface that provides in real time the machine-readable message to a remote service center and receives an indication related to dispatch of a replacement for the component.

### CROSS REFERENCE TO RELATED APPLICATION(S)

This application claims priority from U.S. Provisional Application 61/006,793 filed Jan. 31, 2008 entitled “Automated Repair System and Method For Network-Addressable Components” the content of which is incorporated herein in its entirety to the extent that it is consistent with this invention and application.

### TECHNICAL FIELD

The technical field is automated monitoring and repair of network-addressable components.

### BACKGROUND

Current computer networks typically require an end user of that network, in association with a service provider (often the entity that installed or otherwise provided the computer network), to perform a multitude of activities whenever a fault occurs with the computer network or its addressable components. These activities include manual tasks, such as reading LED status, interpreting event messages and files, copying serial numbers and model numbers, and referencing user and maintenance manuals, to obtain configuration, error, and troubleshooting information. In these systems, if a diagnostic tool is available and is applicable to a particular problem with the computer network and its addressable components, some of the configuration and error information tasks may be partly automated, but not enough of the tasks will be automated so as to largely or completely automate the required repair process. Moreover, in current systems, the repair process typically runs as a standalone application, separate from management and support applications. The enterprise hosting the computer network therefore necessarily loses the benefits of having a repair process that is integrated with its management and support applications.

This lack of integration and task automation presents problems in large enterprises where the end user and the service providers together are required to service and maintain thousands of devices from different vendors comprising varying technologies, product families, and models. The result often is increased service costs and device downtime due to reduced First Time Fix, increased No Material Use calls, increased Parts Per Event, and increased Onsite Dispatch calls.

### SUMMARY

What is disclosed is a system, implemented on a suitable computing device, for automated repair of network-addressable components in an enterprise. The system includes a service event filter in communication with software agents, wherein the service event filter receives the information related to the operation of the component and in real time determines if the received information indicates a serviceable event; and a service event analyzer coupled to the service event filter. The service event analyzer determines in real time an applicable procedure for repair or replacement of the component, and formats in real time the information related to the operation of the component and the applicable procedure into a machine-readable message. Finally, the system includes a serviceable event interface that provides in real time the machine-readable message to a remote service center and receives an indication related to dispatch of a replacement for the component.

Also disclosed is a method, executed on a suitable computing device, for automated repair of network-addressable components. The method includes the steps of receiving information obtained by software agents resident on the components, filtering the obtained information in real time to determine the existence of a serviceable event; when a serviceable event exists, analyzing in real time the obtained information to determine an applicable procedure for repair or replacement of the component; formatting in real time the information related to the operation of the component and the applicable procedure into a machine-readable message; providing in real time the machine-readable message to a remote service center; and receiving an indication related to dispatch of a replacement for the component.

### DESCRIPTION OF THE DRAWINGS

The detailed description will refer to the following drawings in which like numerals refer to like items, and in which:

FIGS. 1A and 1B illustrate exemplary environments in which an automated repair system and method operate;

FIG. 2 is a block diagram of components of the automated repair system;

FIG. 3 illustrates the information flow generally observable in the environment of FIGS. 1A and 1B;

FIG. 4 illustrates a common event callout structure

FIGS. 5A and 5B illustrate examples of management event and serviceable event messages;

FIG. 6 illustrates a serviceable event as displayed on a graphical user interface; and

FIG. 7 is a flowchart illustrating an embodiment of a real-time automated repair method.

### DETAILED DESCRIPTION

The herein disclosed automated repair system, and corresponding method, provide for the largely automated repair of a computer network and its addressable components. The system and method automate tasks associated with diagnosing problems, identifying repair procedures and replacement parts, determining system entitlement, creating support cases, and ordering, delivering, and installing parts.

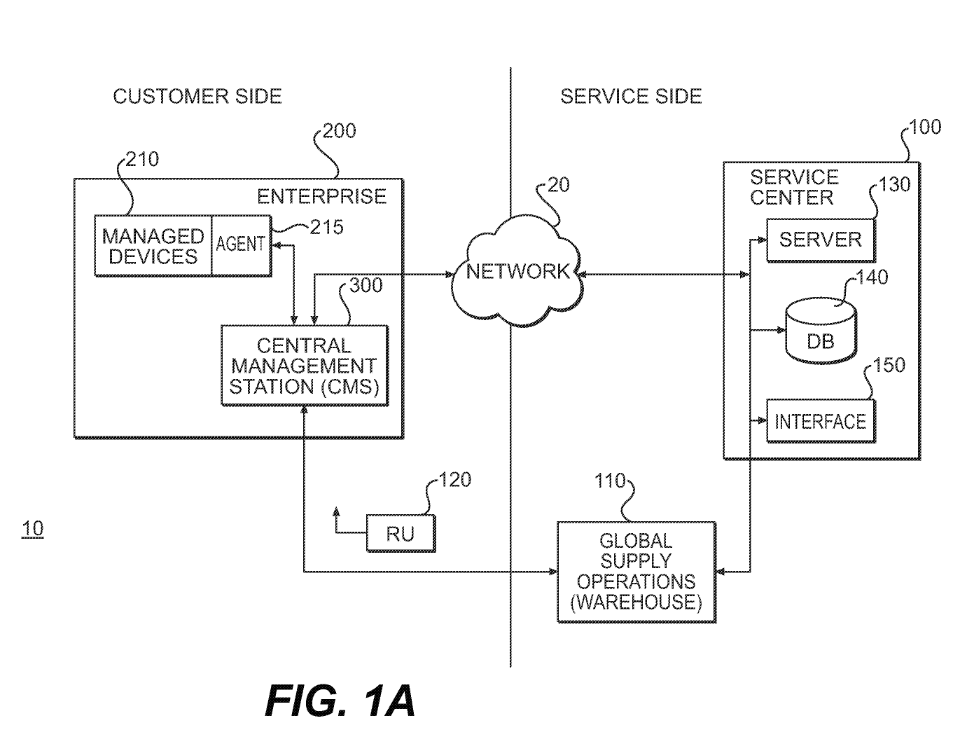

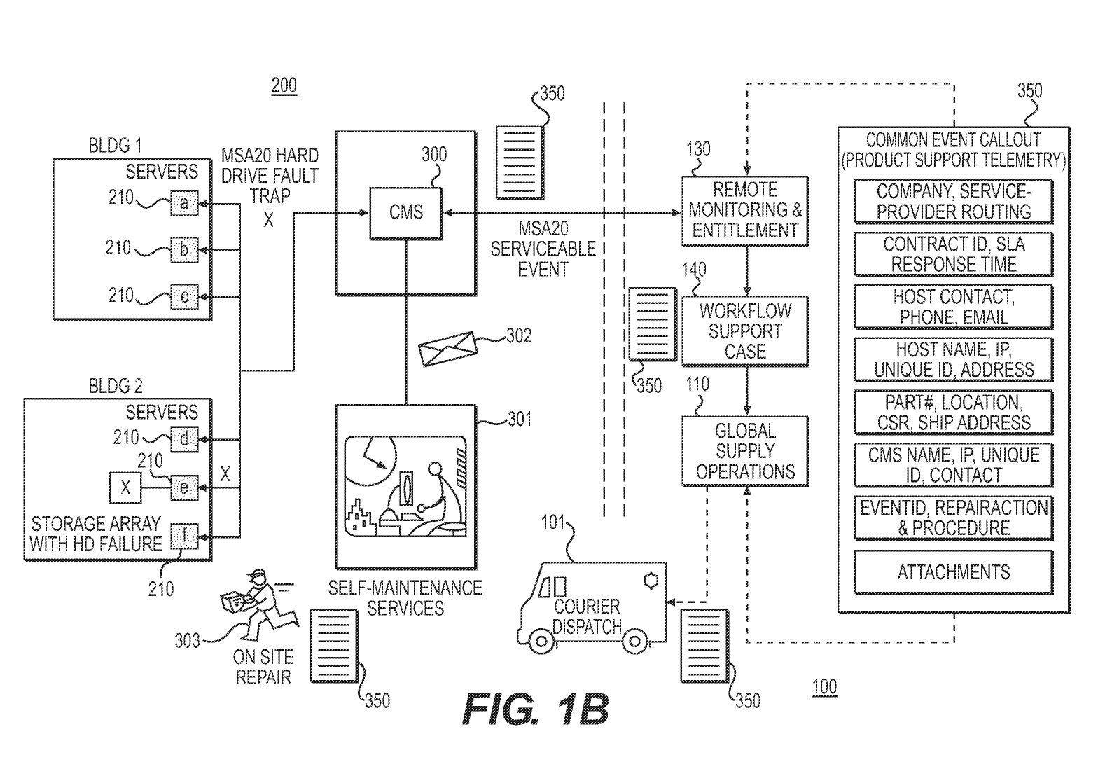

FIG. 1A illustrates an environment 10 in which an embodiment of the automated repair system operates. The automated repair system, and corresponding method, is based in part on existing network management protocols and operating system facilities such as the Simple Network Management Protocol (SNMP), which forms part of the Internet protocol suite, protocols based on the Common Information Model (CIM) such as Web-Based Enterprise Management (WBEM), and binary event logs. Those skilled in the art recognize that these protocols provide a framework to monitor network-attached devices for conditions that warrant administrative attention. For example, SNMP consists of a set of standards for network management, including an Application Layer protocol, a database schema, and a set of data objects. SNMP exposes management data in the form of variables on the managed systems, which describe the system configuration. These variables can then be queried (and sometimes set) by managing applications. In typical SNMP usage, there are a number of devices to be managed, and one or more systems managing the devices. An SNMP agent runs on each managed device and reports information using SNMP protocols to the managing systems.

Essentially, the software or embedded firmware agents expose management data on the managed devices as variables (such as “free memory,” “system name,” “number of running processes,” and “default route”). With the SNMP protocol, for example, the managing system can retrieve the information through GET, GETNEXT and GETBULK protocol operations or the SNMP agent will send data without being asked using TRAP or INFORM protocol operations. Management systems also can send configuration updates or controlling requests through the SET protocol operation to actively manage a system. Configuration and control operations are used only when changes are needed to the network infrastructure. The monitoring operations may be performed on a regular basis.

The variables accessible via SNMP are organized in hierarchies. These hierarchies, and other metadata (such as type and description of the variable), are described by Management Information Bases (MIBs). SNMP itself does not define what information (which variables) a managed device should offer. Rather, SNMP uses an extensible design, where the available information is defined by MIBs. MIBs describe the structure of the management data of a device subsystem; they use a hierarchical namespace containing object identifiers (OID). Roughly speaking, each OID identifies a variable that can be read or set via SNMP. MIBs use a notation defined by ASN.1.

The MIB hierarchy can be depicted as a tree with a nameless root, the levels of which are assigned by different organizations. The top-level MIB OIDs belong to different standards organizations, while lower-level object IDs are allocated by associated organizations. This model permits management across all layers of the OSI reference model, extending into applications such as databases, email, and the Java EE reference model, as MIBs can be defined for all such area-specific information and operations.

A managed object (sometimes called a MIB object, an object, or a MIB) is one of any number of specific characteristics of a managed device. Managed objects comprise one or more object instances (identified by their OIDs), which are essentially variables. Two types of managed objects exist: scalar objects, which define a single object instance; and tabular objects, which define multiple related object instances that are grouped in MIB tables.

An object identifier (or object ID or OID) uniquely identifies a managed object in the MIB hierarchy.

In telecommunications and computer networking, Abstract Syntax Notation One (ASN.1) is a standard and flexible notation that describes data structures for representing, encoding, transmitting, and decoding data. ANS.1, a joint ISO and ITU-T standard, provides a set of formal rules for describing the structure of objects that are independent of machine-specific encoding techniques and is a precise, formal notation that removes ambiguities. An adapted subset of ASN.1, Structure of Management Information (SMI), is specified in SNMP to define sets of related MIB objects; these sets are termed MIB modules.

As noted above, a managed network consists of three key components: managed devices, agents, and management systems. A managed device is a network-addressable component that contains a management agent and that resides on a managed network. Managed devices collect and store management information and make this information available to management systems. Managed devices can be any type of device including, but not limited to, routers and access servers, switches and bridges, hubs, SAN arrays, storage devices, environmental monitors, computer hosts, or printers.

An agent is a network-management software module that resides in a managed device. An agent has local knowledge of management information and translates that information into a form compatible with that agent's system management protocol.

A management system executes applications that monitor and control managed devices. Management systems provide the bulk of the processing and memory resources required for network management. One or more management systems may exist on any managed network.

In FIG. 1A, enterprise 200 includes a number of managed devices 210, which are network-addressable components. Associated with each of the managed devices is at least one management agent 215. A central management station 300 is connected to the managed devices 210 and is used to monitor operation and repair of the managed devices 210. The central management station 300 includes hardware, firmware, and software components necessary to execute management service functions related to the managed devices 210. The hardware includes computing devices and memory units that together are programmed with and store the requisite software. The central management station software may be provided as a bundled package that integrates with other management software.

In FIG. 1A, the enterprise 200 is shown as a single entity. However, the enterprise 200 may include geographically distant locations, and the managed devices 210 and the central management station 300 may be linked by any known communications means. Further, each such geographically separated enterprise site may have its own central management station 300, and the functions of the central management station 300 may be dispersed or centralized according to the particular needs and desires of the enterprise 200.

Coupled to the enterprise 200 is service center 100. The enterprise 200 and the service center 100 are coupled by network 20, which may be any known type of network including, for example, the Internet. The service center 100 includes a server 130 or similar computing platform, database 140, and a user interface (UI) 150. In an embodiment, also part of the service center 100 is warehouse 110. Alternately, the warehouse 110 may be a standalone entity, such as a third-party parts supplier. In either embodiment, the warehouse 110 provides repair parts (replacement units (RUs)) 120 to the enterprise 200. The warehouse 110 may exist as a “brick and mortar” establishment. Alternatively, or in addition, the warehouse 110 may exist as a virtual warehouse. Such a virtual warehouse could, for example, be used to supply software fixes to the enterprise 200 by delivery of software over a communications network, including the network 20.

The server 130 includes the management software and routines to communicate with the service center 100, communicate with the enterprise 200, and dispatch parts, repair information, and service center personnel (if needed). The database 140 includes a log of service incidents reported by the enterprise 200 as well as system information, and service obligation information related to managed devices 210 at the enterprise 200. The server 130 and the database 140 together allow the service center 100 to provide the automated functions of entitlement verification, by consulting business process rules to determine if a replaceable unit is covered under a warranty or contract, support case creation, which opens an electronic trouble ticket file for the service incident and provides requisite notifications and tracking, and replaceable unit dispatch by linking into the logistics and global delivery operations systems. The interface 150 allows a human operator at the service center to interact with the server 130, including viewing service incidents and related data that are provided by way of a graphical user interface (GUI).

FIG. 1B shows another view of the environment 10 with service processes illustrated in more detail. Enterprise 200 includes a number of managed devices 210 that are monitored by central management station 300. As shown in FIG. 1B, a hard drive failure has occurred in a storage array associated with managed device 210e. The failure is reported to the central management station 300 as a hard drive fault trap. The central management station 300 determines, based on a set of on-site rules, that the hard drive failure constitutes a serviceable event, and reports the failure to service center 100 as a service incident. The service incident provides the necessary problem diagnosis, part dispatch, self-repair procedures and system entitlement information. The central management station 300 also notifies enterprise personnel, including enterprise self-maintenance personnel 301 of the failure using, for example, email 302.

When the service incident arrives at the service center 100, the information contained therein is used by the server 130 to determine if the failed component (the hard drive) is entitled to repair/replacement. The information is contained in a standard callout 350, which is used to format the service event and service incident, as automated product support telemetry. As shown in FIG. 1B, the callout 350 follows the flow of information from the CMS 300, to the service center 100, and therein through the components of the service center 100 and back to the enterprise 200 with the replaceable unit (RU). If the failed part is entitled to repair/replacement, a workflow support case is established and stored in database 140, and information needed to obtain the replacement unit from inventory is sent to global supply operations 110. The replacement unit then is dispatched, by courier dispatch 101 for example, to the enterprise site, where enterprise personnel 303 receive and install the replacement unit. In the environment shown in FIG. 1B, all operations, from sending the management event to identifying and dispatching the replacement unit, are automated (i.e., they may proceed without human involvement), based on information supplied by the standard callout 350, and parsed by the various automated functions in the service center 100. Furthermore, the CMS 300 and the server 130 communicate automatically regarding the status of repair/replacement of the failed component until the case opened for the hard drive fault is closed.

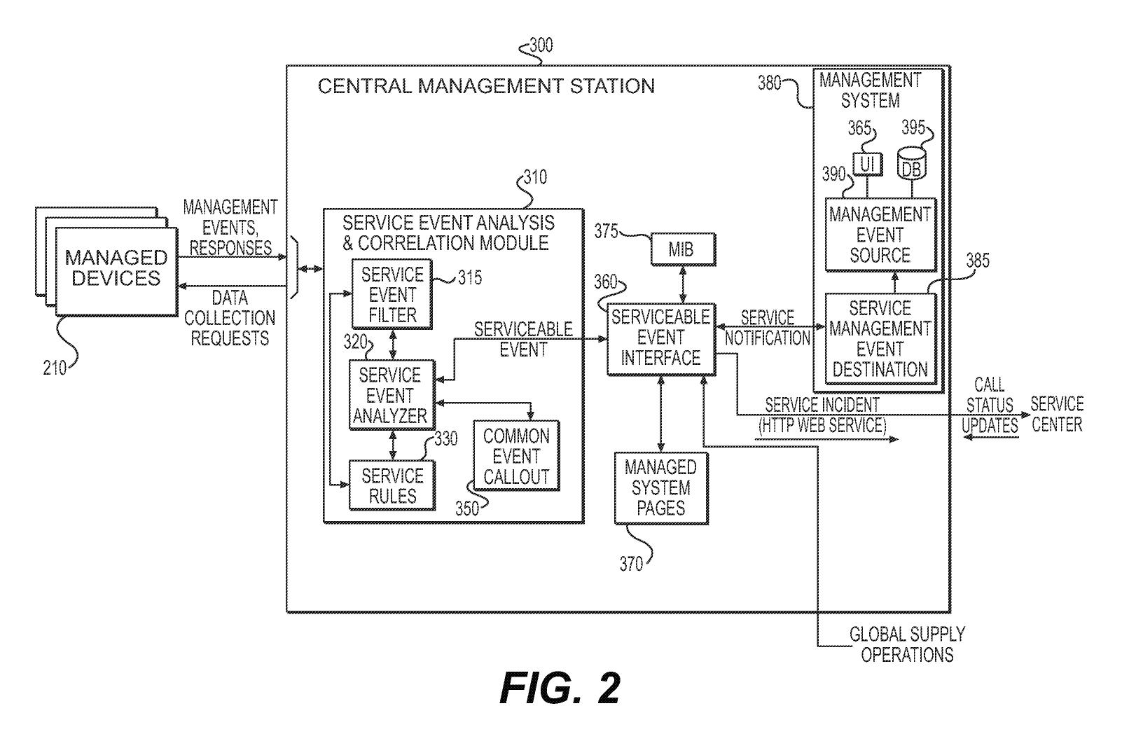

FIG. 2 shows the central management station 300 in more detail. The station 300 is in communication with the managed devices 210. Operational status information related to the managed devices 210 is transferred between the managed devices 210 and the station 300 by a series of management events and data collection requests and responses (in SNMP parlance, traps, gets, and get responses). In essence, a management event (trap) is a notification and data delivery mechanism in which raw data specific to a management device is obtained, according to a predetermined format, by a data collection agent (not shown) resident on the managed device 210. Use of data collection agents to obtain status information is well known to those skilled in the art. A data collection event (get) is a communications device by which components of the station 300 seek to extract data from the managed devices 210. For example, a data collection event may be used to ascertain the type of a dual inline memory module (DIMM), where such data are available from an eeprom on the DIMM.

An analysis and correlation module resident at the central management station 300 performs real-time analysis on the raw data and generates a serviceable event, which consists of data compiled into a specific format that is parseable and readable by applications resident at both the enterprise 200 and the service center 100. The serviceable event information is reported by a serviceable event interface to management modules at the central management station 300 and at the service center 100. The service center 100 uses the thus-reported service incident to create a support case. Finally, the service center 100 uses the serviceable event to dispatch repair/replacement parts and repair/replacement procedures to allow enterprise personnel to execute a self-repair of the managed device 210.

Each of the managed devices 210 may be capable of repair either by members of the enterprise 200, by members of the service center 100, or by both. In addition, certain managed devices 200 may be capable of automated repair; that is, repair procedures performed without a human operator. Automated repair procedures include replacement of software, switchover to redundant parts, or repairs implemented by automatons and automated processes.

Each of the managed devices 210 may be repaired under some form of warranty or service contract. As such, the automated repair system will note those managed devices 210, or subcomponents thereof, that are entitled to repair supported by the service center 100.

Each of the managed devices 210 may consist of a number of discrete components. Each such discrete component may be identifiable by part type, physical location within the enterprise 200 (e.g., at a specific geographical location, in a specific rack, in a specific bay), serial number, manufacturer, or performance characteristics, for example. The identifying information may be embedded in the component by the component manufacturer. For example, a DIMM manufacturer may embed the manufacturer name and part number in the DIMM in such a way that the identifying information is readily retrievable by an agent. In the case of a DIMM, such information may be provided by a readout on the DIMM itself. For components of managed devices 210, or the managed devices themselves, the identifying data may be provided by the component manufacturer according to an industry standard such as Joint Electron Device Engineering Council (JEDEC) or Intelligent Platform Management Interface (IPMI) component specifications, for example. For components that do not contain such manufacturer-supplied data, the agents may be capable of identifying the component by its readily-identifiable features.

Each of the managed devices 210 may be subject to a number of events. Certain of these events are serviceable events. Serviceable events may involve the replacement of a replaceable unit (RU). Serviceable events may take many forms, including faults with one or more components of the managed device, exceeding performance characteristics or capacity of the managed device (e.g., a demand for storage in excess of 100 percent of the storage capacity of the managed device), time in service, incompatibility with a new or replacement component of the managed device, a new model or design for an existing component, existence of an enterprise-provided set point or threshold, and correlation to another event with a component of the managed device.

Replaceable units may be individual components of a managed device that are replaceable by members of a service organization or the enterprise 200. Examples of RUs are power supplies, memory modules, and cooling fans.

An event may be designated as a serviceable event based on a set of rules that are unique to the enterprise 200, are designed for each specific managed device in its existing networked environment, or that are specific to individual components of the managed devices. Examples of such rules include whether a component is capable of repair or replacement, and whether an event requires local only notification or service center notification also.

In FIG. 2, the information provided from the managed devices 210 is input to a serviceable event analysis and correlation module 310. The information reported by the managed devices 210 is formatted as a management event according to the specific protocol used in the central management station 300. For example, with SNMP protocols, the information is provided by SNMP traps and gets. The module 310 is the first component of the station 300 that is used to determine if the information provided from the managed device 210 constitutes a serviceable event. For example, for a managed device having an uninterruptible power supply (UPS), a battery failure may give rise to a serviceable event. To determine if such an event exists, data collection agents in the managed device 210 monitor and report battery status information. The battery status information may include output voltage, temperature, and current. When one or more of these parameters reaches a threshold value, a battery status serviceable event may be declared. The module 310 is programmed to read the information input from the managed device and determine if a serviceable event has occurred. However, in some cases, the information from the managed device 210 may not be sufficient to make such a determination. For example, the managed device 210 may not provide a specific location or part number of the component. When the module 310 receives information in the form of a management event from the managed device, the module 310 will determine if the management event contains sufficient information to declare a serviceable event. If the management event does not include sufficient information to declare a serviceable event, the module 310 may send a data collection request back to the managed device 210 to obtain the missing information (if possible). The agent resident on the managed device 210 will, if possible, then obtain the required information and pass that information to the module 310. If the required information cannot be obtained from the managed device 210, the module 310 may generate a message locally indicating an event of interest to the enterprise 200, but may not complete the formatting needed to generate a service incident to the service center 100.

Within the module 310, a service event filter 315 receives the information from the agents and processes that information to determine if a serviceable event exists within the managed device 210. Determination of the existence of a serviceable event is based on a set of onsite service rules 330. A service event analyzer 320 receives an output from the service event filter 315 and analyses the output information to determine if additional information is required from the managed device 210. The service event analyzer 320 also analyzes the output information to determine the nature of the failure or other reported circumstance, correlate the information with other event management reports, analyze the information to determination the range of repair/replacement actions that are available so as to generate a recommended service action.

The service event analyzer 320 then transforms the information into a serviceable event message according to a common event callout schema 350. The serviceable event message is then provided to serviceable event interface 360.

The serviceable event interface 360 provides the support telemetry needed to enable remote execution of certain functions including entitlement determination, support case creation, and replaceable unit dispatch. The interface 360 is used to send service incidents to the service center 100 and service notifications to a management system 380 within the station 300, to receive service incidents and case updates from the service center 100, and to receive replacement unit information and status from the global delivery operations 110. The serviceable event messages may be sent according to protocol-specific requirements (e.g., SNMP protocols) or as SOAP messages. SOAP messages allow bi-directional message traffic so that the interface 360 can communicate with and have access to data in the management system 380. Other message formats also may be used to send the serviceable event messages. The interface 360 also is used to coordinate links between the initial received serviceable event, the logging of the service incidents to the service center 100, the current status of a logged service incident, and the recommended service action. Using SOAP messaging protocols, the interface 360 allows external applications to add, update, and remove logged events. In addition, each logged event can be correlated to the original trap. This correlation allows the enterprise 200 to easily locate the original problem when the service incident is sent to the service center 100 and allows external applications to update the database 140 with new status regarding the serviceable event.

The serviceable event interface 360 receives inputs formatted based on a service MIB (management information base) 375 and a managed system pages module 370. The service MIB 375 defines the data structure of the management events used by the agents 215. The format of the management events may be supplied by various standards setting organizations. In an embodiment, the service MIB 375 uses the notation defined in ANS.1. The enterprise 200 also can specify the format of the management events.

The managed system pages module 370 specifies information that normally would pertain to each of the managed devices 210, or components thereof. Using the module 370, members of the enterprise 210 can add system location and system contact information to the descriptions (pages) that describe the managed devices.

The management system 380 includes service management event destination 385, management source 390, database 395, and user interface 365. The service management event destination 385 receives service notifications from the interface 360 and provides service information to the management event source 390. The database 395 includes information related to discovered devices (i.e., managed devices 210 on the enterprise's network) and events of interests, including serviceable events, related to these discovered devices. Finally, user interface 365 provides a means for a human user to interact with the management system 380 and other components of the station 300, including viewing serviceable event messages.

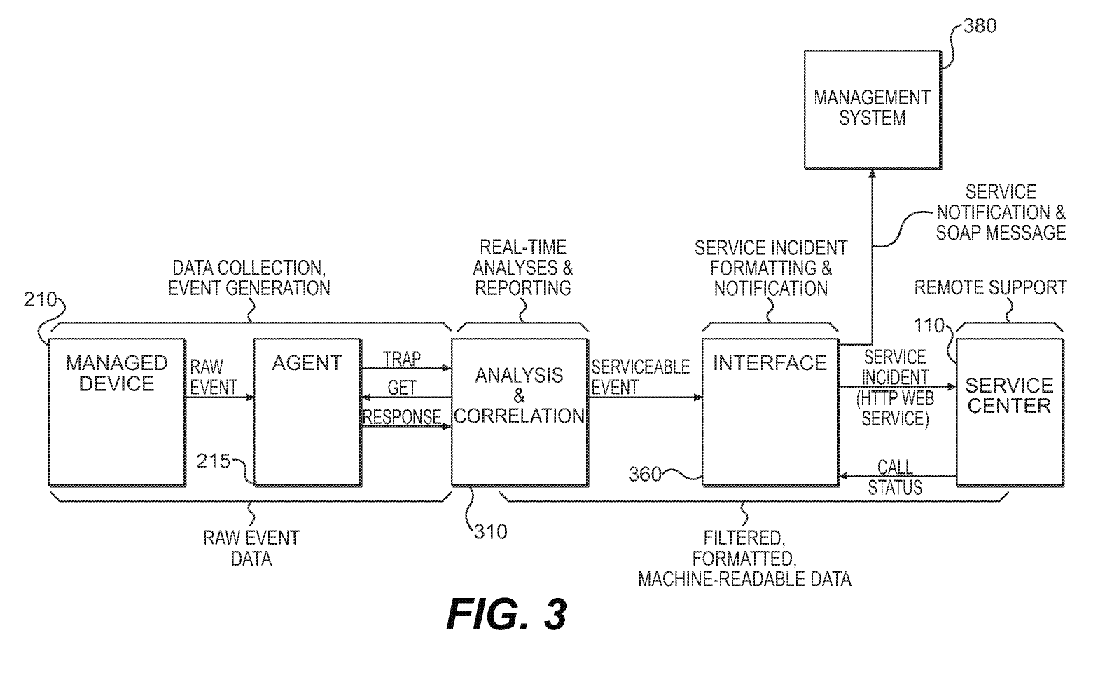

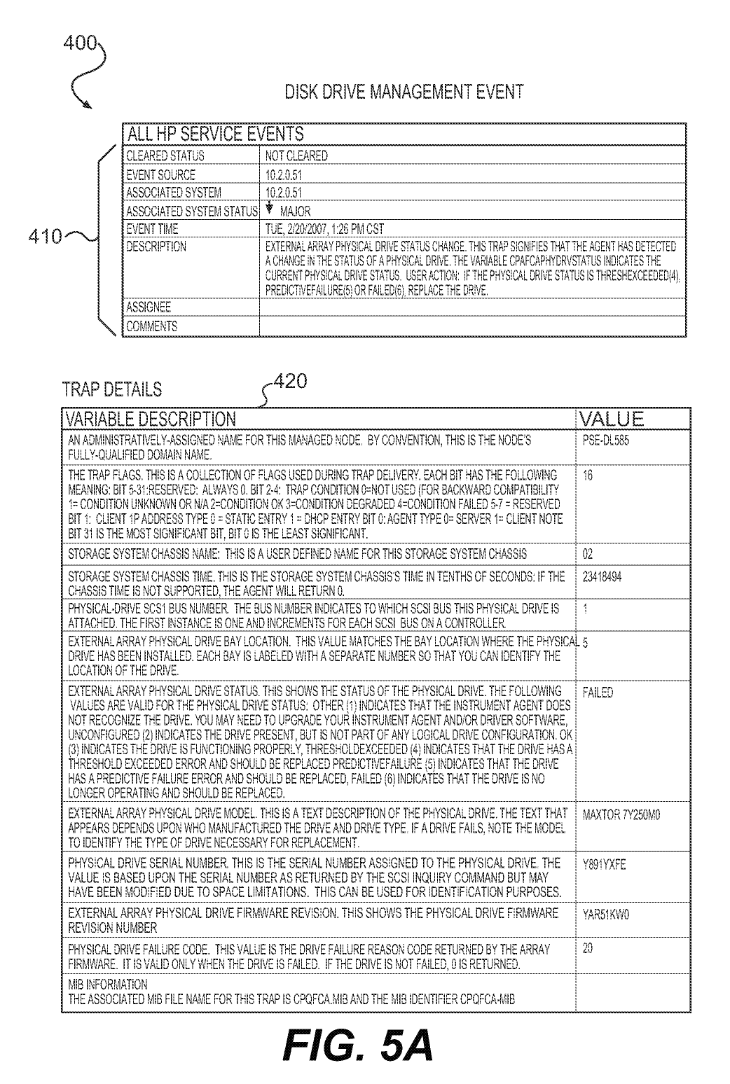

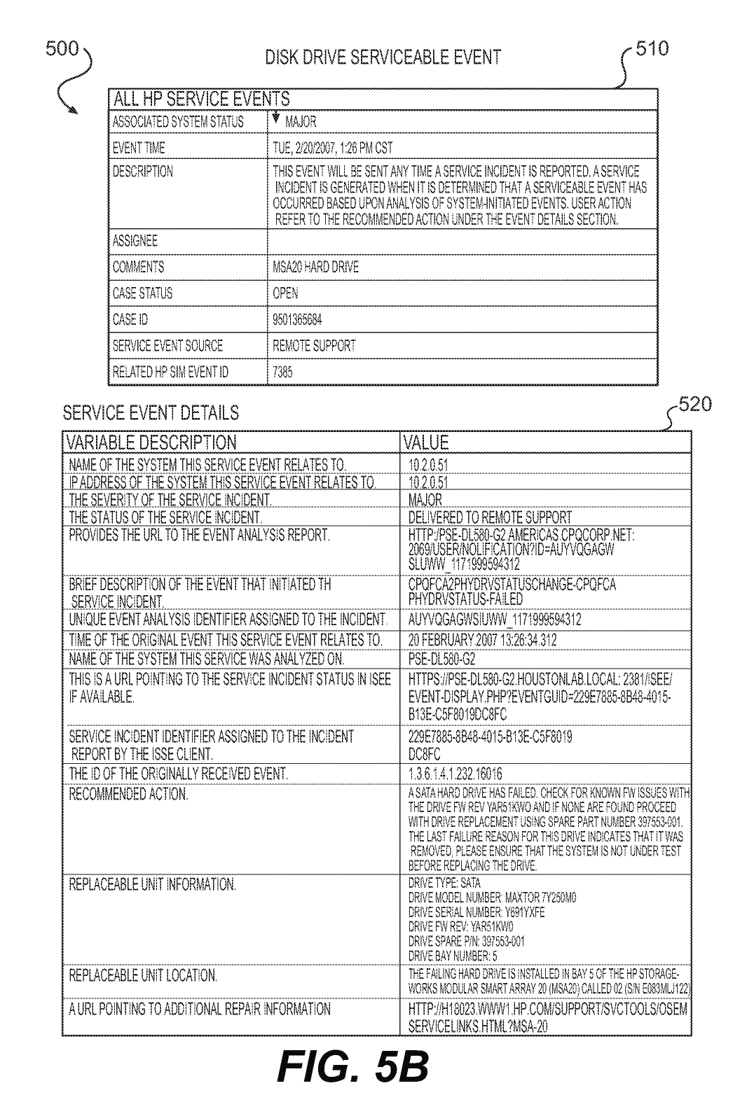

FIG. 3 illustrates the information flow generally observable in the environment 10 of FIG. 1A. A managed device 210 contains configuration, performance, health, and other information that is collectable by agent 215. The agent 215 may collect specific information according to a set format, or management event. The information may be collected periodically, or upon the occurrence of a specific circumstance. For example, the agent 215 may record ambient temperature within an enclosed cabinet when that temperature reaches a threshold value. The reported temperature may be provided along time and date, location, part number, and other information, as specified in a trap. The managed device 210 in collaboration with the agent 215 constitute the data collection and management event generation part of the information flow in the environment 10 of FIG. 1A. The management event is provided in real-time by the agent 215 to the analysis and correlation module 310. Components within the module 310 analyze the reported information and determine if a serviceable event should be declared. In some cases, the module 310 will determine that additional information is required from the managed device 210. In these cases, the module 310 sends a data collection event (e.g., a get) back to the managed device 210, and the agent 215, collects that information, if possible, and reports the additional information to the module 310 by way of a data collection event response. Within the module 310, the collected event information from the management event is formatted into a serviceable event message, and example of which is shown in FIG. 5B.

When a serviceable event is declared, the module 310 provides a serviceable event message to serviceable event interface 360. The serviceable event message is prepared from the management event and additional gathered information and analysis thereof. An example of the serviceable event message is shown in FIG. 5B. The serviceable event interface 360 provides the serviceable event message to the management system 380. The thus-provided serviceable event message may be provided as a Simple Object Access Protocol (SOAP) message. The interface 360 also provides a service incident to the service center 100. In response to the service incident, the service center 100 may dispatch one or more parts to the enterprise 200, and may report the dispatch of these parts to the serviceable event interface 360. The service incident adheres to the common information model implements as extensible HP-service incident XML content with well defined tags.

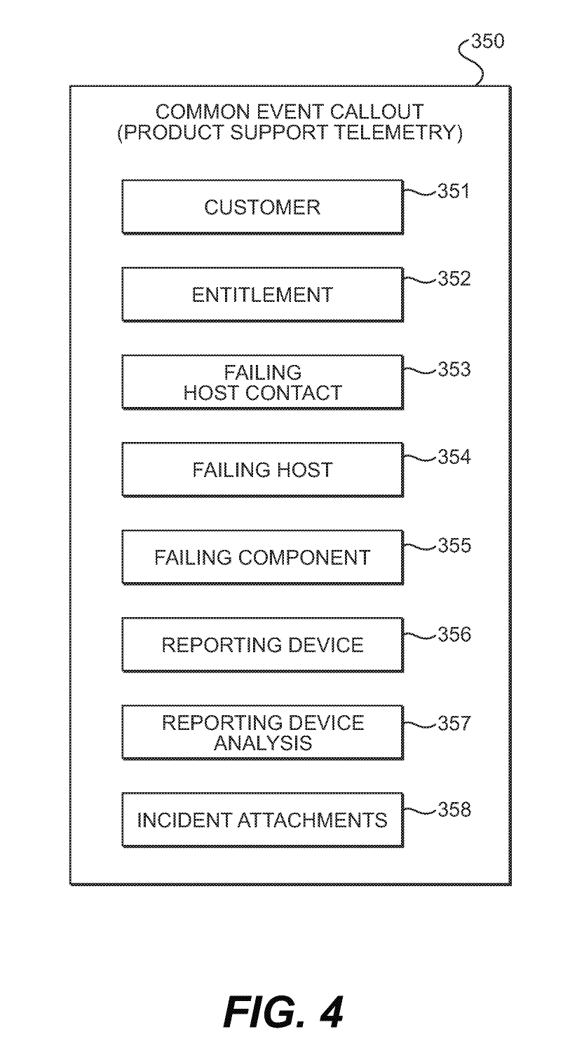

The support telemetry information presented in the serviceable event message follows a common event callout structure. FIG. 4 illustrates an embodiment of the common event callout structure 350. The common event callout structure 350 defines the minimum usable content that is needed for problem diagnosis and additional information needed for global delivery operations. In FIG. 4, the common event callout structure 350 includes customer information 351 identifying and describing the enterprise or customer, unique system identification and entitlement information 352 required to validate service obligation and support authorization, contact information 353 required to contact the failing host, failing host information 354 identifying and/or about the failing host, component information 355 identifying the failing component, including failing RU, model, and serial number, reporting device information 356 identifying the device reporting the serviceable event, analysis information 357 including the basic event information, problem description, and recommended corrective action, and incident attachments 358, such as configuration logs added to the serviceable event messages, which provides additional information about the event.

The first five elements of the common event callout structure (i.e., elements 351-355) provide information required to open a support call electronically at the support center 100, including identifying the enterprise, the type of managed device and its location, and to identify and dispatch the required repair/replacement parts. The next three elements provide all the information needed for an enterprise person to perform a self repair of the managed device 210, including, for example, a URL link to a step-by-step video repair procedure. All of this information is provided in real time immediately after the fault or problem occurs and is reported by the serviceable event. The information provided is very accessible and easy to view and understand. Moreover, the information is machine-readable over well-defined APIs by applications resident at the enterprise 200 and the service center 100. The information includes recommended service action to inform enterprise personnel as to repair actions that need to be taken, and replacement parts that need to be ordered. The common event callout structure integrates the use of Service Media Library (SML) streaming procedures that provide both a visual and narrative procedure for replacing the failed component called out by the service event analyzer 320. A hyperlink is inserted into the analysis information 357 to link to an appropriate external Web page that allows the enterprise personnel to find the location of the failed component and see and listen to a detailed repair procedure on how the component is removed and replaced for the specific managed device 210.

FIGS. 5A and 5B show embodiments of a managed event and a corresponding serviceable event. The example illustrated is for a disk drive. In FIG. 5A, disk drive management event 400 is used to report information from a failing disk drive unit. In section 410, summary information, including location (i.e., IP address), type of event (major), event description, and other information is recorded. In section 420, the physical location of the device is stated, the failure modes are stated, the device is identified, and the MIB corresponding to the trap is stated, among other information. The service event filter 315 will review the management event information and determine if a serviceable event exists. The service event analyzer 320 determines if the service event filter 315 should try to obtain additional information from the management agent 215 on the managed device 210.

In FIG. 5B, disk drive serviceable event 500 is illustrated. In section 510, the disk drive is identified and a case number is assigned. The case number is logged at the service center 100 and is used to track the status of the serviceable event. In section 520, the serviceable event 500 records information related to the repair/replacement of the disk drive including the recommended repair action and a URL to a site that provides information related to the repair including, for example, a video illustrating how the repair should be completed, and detailed written repair procedures.

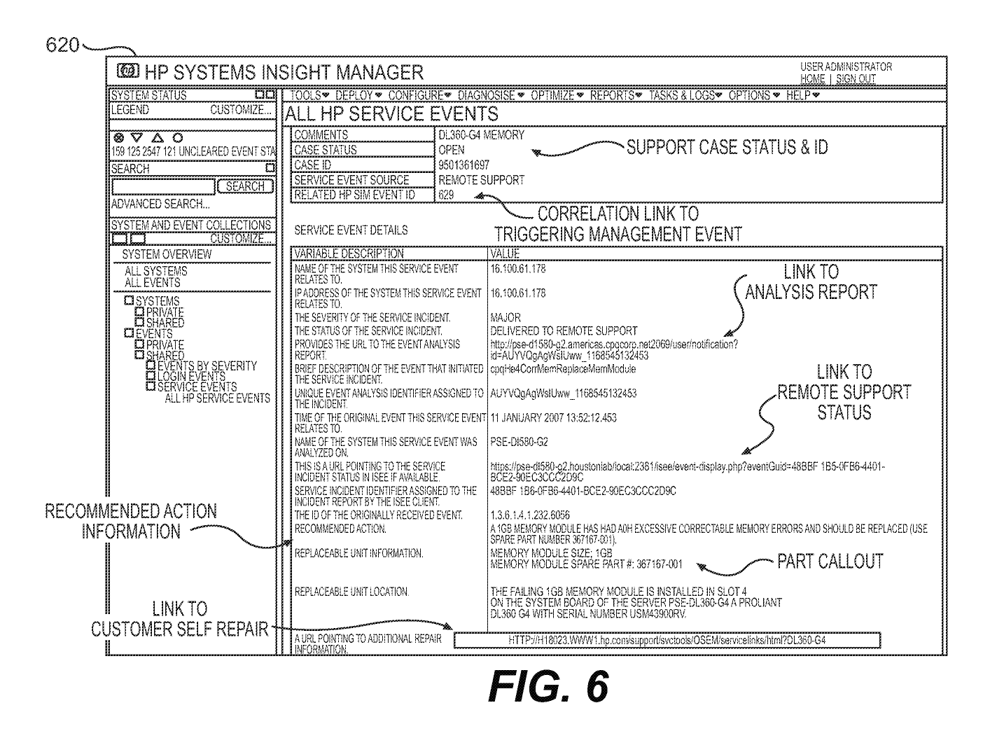

FIG. 6 illustrates an embodiment of a serviceable event message 620 as shown on a graphical user interface on the display 150 of FIG. 1A. A similar display is available at the central management station 300 of FIG. 3.

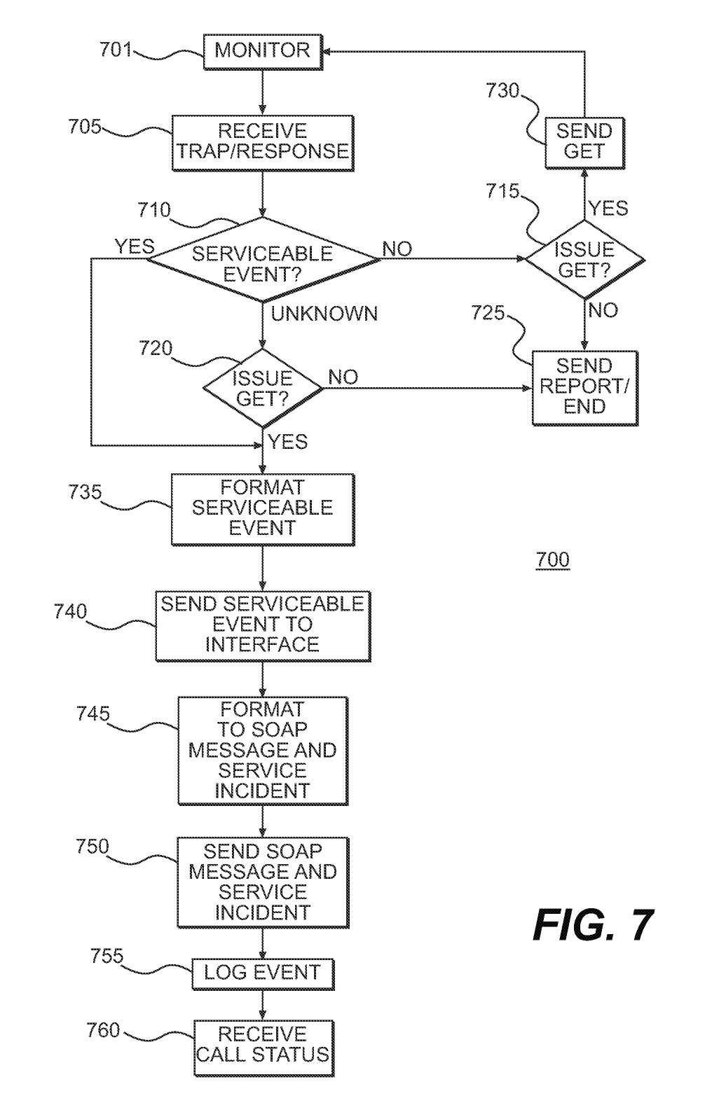

FIG. 7 is a flowchart illustrating an embodiment of a real-time automated repair procedure as invoked using the CMS 300 of FIG. 3. The repair procedure is implemented by the various software routines illustrated in FIG. 3, as constituted on various servers and other hardware components of the enterprise 200.

In FIG. 7, real-time automated repair procedure 700 begins in block 701 with the CMS 300 monitoring operation of the managed devices 210. In block 705, an SNMP agent at a managed device 210 sends a management event or data collection event response to the module 310. In block 710, the module 310 determines if the data contained in the trap or response constitutes a serviceable event, is not a serviceable event, or is indeterminate. In making this determination, the module 310 determines if the nature of the problem is such that a repair is warranted. The module 310 also determines if the repair to the managed device 210, or component thereof, is a replaceable unit (RU). Finally, the module 310 determines if the enterprise 200 is entitled to a repair by the service center because the managed device 210, or component thereof, is under warranty or if some other contractual obligation exists to make the repair. For example, the failing component may be one of several similar components within the managed device, and the appropriate repair procedure call from replacement of all such components when any one component is replaced. In addition, the designated replacement part may be an upgraded part, and replacement of one upgraded part requires that all other similar parts similarly be upgraded. Still further, replacement of a failing part with an upgraded part may require installation of a later software version. Such software may be installed by enterprise personnel or service center possible coincident with replacement of the failing component. Alternatively, the upgraded software may be sent over the network 20 and installed automatically at next system boot, or other operation of the managed device 210. In yet another alternative, replacement of one failing component may call for the replacement of a related component. For example, replacement of a power supply may call for replacement of an associated cooling system component, such as a fan. Any and all of these and other possible component repair/replacement scenarios may be subject to a service agreement between the enterprise 200 and the service center 100. To implement these repair/replacement scenarios, various components of the CMS 300 are programmed to reflect the entitled actions. For example, the service rules 330, the service MIB 375, and the managed system pages 370 all may reflect these service scenarios.

If a serviceable event does not exist, based on the trap data, the procedure 700 proceeds to block 715, and the service event analyzer 320 determines if additional information should be obtained from the managed device 210. If additional information should be not obtained, the procedure 700 moves to block 725 and the service event analyzer 320 sends a message to the service event interface 360 indicating the nature of the problem reported by the SNMP trap or response along with information to identify the affected component and managed device 210. The service event interface 360 may convert this information into a SOAP message and then pass the SOAP message to the management system 380, where the information is recorded for future analysis and possible correlation with prior or subsequent problems and events. The procedure 700 then ends.

In block 710, if the determination of a serviceable event is undetermined, the procedure moves to block 720. In block 720, the service event analyzer 320 determines if additional information should be and/or is possibly available from the managed device 210. If such information is not available, the procedure 700 moves to block 725. If such information should be and/or is possibly available from the managed device 210, the procedure 700 moves to block 730.

Returning to block 715, if the service event analyzer 320 determines that additional information should be obtained from the managed device 210, the procedure moves to block 730. In block 730, the service event filter 315 sends a SNMP get or similar data request to the managed device 210. The procedure 700 then returns to block 701.

Returning to block 710, if the module 310 determines that a serviceable event has occurred, the procedure 700 moves to block 735. In block 735, the information related to the serviceable event is formatted into a serviceable event message according to the common event callout structure 350. The thus-formatted serviceable event message can be parsed and read by applications resident at the service center 100 and the CMS 300 to provide logging and tracking of event status, repair parts ordering and dispatch, dispatch of repair procedures, if applicable, and scheduling and dispatch of service center personnel, if applicable. Next, in block 740, the serviceable event message is sent to the serviceable event interface 360, where the message may be converted into a service incident and a SOAP message format, block 745. The service incident and SOAP message then are sent, block 750, to the service center 100 and the management system 380, respectively. In block 755, the serviceable event is logged in the management system 380. In block 760, the serviceable event interface 360 receives call status information. The procedure 700 then ends.

Returning to FIG. 1A, what is shown includes an apparatus that can perform the steps of the procedure 700 of FIG. 7. In an embodiment, at least one of the above-described steps of the procedure 700 can correspond to instructions stored in one or more memory units. Instructions stored in a memory unit can be executed or performed by one or more computers or servers. The computer is in communication with the memory unit. The memory unit is a computer-readable medium. The memory unit could be any kind of computer memory such as floppy disks, conventional hard disks, removable hard disks, compact discs (CDs), digital versatile discs (DVDs), flash read only memory (flash ROM), nonvolatile read only memory, and random access memory (RAM), for example.

A software implementation of the above-described procedure 700 may comprise a series of computer instructions either fixed on a tangible medium, such as a computer readable media, for example a compact disc or a fixed disk, or transmissible to a computer system via a modem or other interface device over a medium. The medium can be a tangible medium. The series of computer instructions embodies all or part of the functionality previously described herein with respect to the procedure 700. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. Such a computer program product may be distributed as a removable media with accompanying printed or electronic documentation, for example, shrink wrapped software, pre-loaded with a computer system, for example, on system read only memory (ROM) or fixed disk, or distributed from a server or electronic bulletin board over a network, for example, the Internet or World Wide Web.

What is claimed is:

1. A system, implemented on a suitable computing device, for automated repair of network-addressable components, comprising:
a service event filter in communication with software agents, wherein the service event filter receives the information related to the operation of a component and in real time determines if the received information indicates a serviceable event;
a service event analyzer coupled to the service event filter, wherein the service event analyzer:
determines in real time an applicable procedure for repair or replacement of the component, and formats in real time the information related to the operation of the component and the applicable procedure into a machine-readable message;
a serviceable event interface that provides in real time the machine-readable message to a remote service center and receives an indication related to dispatch of a replacement for the component.

2. The system of claim 1, wherein the serviceable event comprises a fault in the component, wherein the component is under warranty or otherwise entitled to replacement.

3. The system of claim 1, wherein the component has generated an event of management interest.

4. The system of claim 1, wherein the software agents are SNMP agents, and wherein information obtained by the SNMP agents is obtained according to one of a trap and a get.

5. The system of claim 4, wherein the service event filter determines if the serviceable event exists based on information contained in a trap, and wherein if the information contained in the trap is insufficient, the service event filter sends a get to the component.

6. The system of claim 4, wherein the information reported in the trap is structured according to a management protocol.

7. The system of claim 1, wherein a machine-readable message is formatted according to a common event callout standard.

8. The system of claim 7, wherein the common event callout standard comprises:
customer information identifying and describing an enterprise;
entitlement information required to validate entitlement and service authorization;
contact information required to contact the enterprise;
failing host information identifying and/or about the enterprise;
component information identifying the component, including failing FRU, model, and serial number;
reporting device information identifying the device reporting the serviceable event; and
analysis information including the basic event information, problem description, and recommended corrective action.

9. A method, executed on a suitable computing device, for automated repair of network-addressable components, comprising:
receiving information obtained using software agents resident on the network-addressable components, the information related to an operation of a component;
filtering the obtained information in real time to determine the existence of a serviceable event;
when a serviceable event exists, analyzing in real time the obtained information to determine an applicable procedure for repair or replacement of the component;
formatting in real time the information related to the operation of the component and the applicable procedure into a machine-readable message;
providing in real time the machine-readable message to a remote service center; and
receiving an indication related to dispatch of a replacement for the component.

10. The method of claim 9, wherein the software agents are SNMP agents, and wherein the information obtained by the SNMP agents is obtained according to one of a trap and a get.

11. The method of claim 10, wherein the serviceable event comprises a fault in the component, wherein determining if a serviceable event exists comprises determining if the component is under warranty or otherwise entitled to replacement.

12. The method of claim 11, wherein determining if a serviceable event exists is based on information contained in the trap, and wherein if the information contained in the trap is insufficient, the method further comprises sending the get to the component.

13. The method of claim 11, wherein the component has reached an time-in-service end of life.

14. The system of claim 10, wherein the information reported in the trap is structured according to a management information base.

15. The system of claim 9, wherein the machine-readable message is formatted according to a common event callout.

16. A system, implemented on a suitable computing device, for automated repair of network-addressable components, the system, comprising:
means for receiving the information related to an operation of the component;
means for real time determination if the received information indicates a serviceable event;
means for real time determination of an applicable procedure for repair or replacement of the component, and
means for real time formatting the information related to the operation of the component and the applicable procedure into a machine-readable message;
means for real time providing the machine-readable message to a remote service center; and,
means for receiving from the remote service center an indication related to dispatch of a replacement for the component.

17. The system of claim 16, wherein the serviceable event comprises a fault in the component, wherein the component is under warranty or otherwise entitled to replacement.

18. The system of claim 1, wherein the means for obtaining information from the component includes traps, gets, and get responses.

19. The system of claim 18, wherein the means for real time determination of a serviceable event comprises means for reading and interpreting the traps and get responses.

20. The system of claim 16, wherein the means for formatting the machine-readable message comprises means for formatting data according to a common event callout structure.
